(19) United States
(12) Patent Application Publication
(10) Pub. No.: US 2006/0178758 A1
(43) Pub. Date: Aug. 10, 2006

(54) Training methods and systems

(75) Inventor: Lior Koriat, Barkan (IL)

Correspondence Address: BROWDY AND NEIMARK, P.L.L.C.;624 NINTH STREET, NW, SUITE 300, WASHINGTON, DC, 20001-5303, US

(73) Assignee: Israel Aircraft Industries Ltd., Lod (IL)

(21) Appl. No.: 11/349,193

(22) Filed: Feb. 8, 2006

Related U.S. Application Data
(60) Provisional application No. 60/650,510, filed on Feb. 8, 2005.

(51) Int. Cl. G05B 11/01

(52) U.S. Cl. 700/12

(57) ABSTRACT

An airborne device, a hybrid trainer and methods are provided, The method includes providing, by an airborne gateway, data representative of at least one virtual entity; sensing, by an airborne sensor, signals representative of at least one real entity; and generating, by an airborne component, data representative of a virtual entity and of a real entity.

### FIELD OF THE INVENTION

The present invention relates to systems and methods for training persona. And especially system and methods that are used to train airborne personnel.

### BACKGROUND OF THE INVENTION

In order to improve the skills of various professionals, and especially highly skilled personnel, various type of trainings were developed. Various prior art trainers (including simulators) as well as prior art training methods are illustrated by the following patents and patent applications, which are incorporated herein by reference: U.S. Pat. No. 5,428,530 of Brown et al, titled “Airborne reactive threat simulator”; U.S. Pat. No. 5,807,109 of Tzidon et al., titled “Airborne avionics simulator system”; U.S. patent application serial No. 2003/0118971 of Rogachev titled “War game complex and method of playing the game”; U.S. patent application serial No. 2004/0029081 of Jaros et al., titled “Airborne simulator”; U.S. patent application serial No. 2002/0039085 of Ebersole et al., titled “Augmented reality display integrated with self-contained breathing apparatus; U.S. Pat. No. 6,053,737 of Babbitt et al., titled “Intelligent flight tutoring system” and U.S. patent application serial No. 2003/0214533 of Cull et al. U.S. Pat. No. 5,428,530 describes an airborne system that sends electromagnetic signals towards a ship while simulating various attacks on that ship. The ship sensors receive the electromagnetic signals and the ship's crew can accordingly execute various countermeasures. Accordingly, the crew is trained to manage various threats. U.S. Pat. No. 5,807,109 illustrates an airborne avionics simulator system integrated into a low-cost host aircraft to simulate the avionics of a high performance aircraft.

U.S. patent application serial No. 2003/0118971 illustrates a war-gaming complex that includes an airfield, ground-based symbolic target-hit means and airborne symbolic target-hit means, whereas the airborne and ground-based means are used during a war game. U.S. patent application serial No. 2004/0029081 illustrates a simulator that includes a crane and ropes that can elevate and rotate suspension modules.

U.S. patent application serial No. 2002/0039085 illustrates a system for training firefighters that includes a breathing mask as well as a display and audio transmitters. U.S. Pat. No. 6,053,737 illustrates an expert system based simulator. U.S. patent application serial No. 2003/0214533 illustrates control panels of a simulated complex system.

Traditional combat training is based upon real vehicles (e.g., real aircraft, unmanned airborne vehicles, ships, armored ground vehicles and the like). Such exercises and training provide experience in real environments for the trainees—for example, real cockpits and real targets. Traditional exercises involve only real entities supplying real data.

Some prior art training method involve exposing participants and vehicles to data relating to real entities by using the real sensors of the vehicle as well as a data link between the vehicle to other vehicles. The sensors may include a radar, a passive electronic warfare system and the like.

FIG. 1 illustrates a prior art traditional training environment 10. Three airborne devices 100, 200 and 300 are carried by three airborne vehicles. These devices exchange status information about friendly forces using data links 99 that are established between their data link gateways 110, 210 and 310 accordingly.

The first airborne device 100 includes a data link gateway 110, system 120, sensor 130 and avionics, control and displays (collectively denoted 140). Components 110-140 are connected to each other by bus 150. System 120 may affect external entities, while sensor 130 can sense real entities. Sensor 130 provides information about real enemy forces as well as real friendly forces that are located within its coverage area.

The second airborne device 200 includes a data link gateway 210, system 220, sensor 230 and avionics, control and displays 240. Components 210-240 are connected to each other by bus 250. The third airborne device 300 includes a data link gateway 310, system 320, sensor 330 and avionics, control and displays 340. Components 310-340 are connected to each other by bus 350. Components 310-350 and 210-250 are analogues to components 110-150.

FIG. 2 illustrates a prior art virtual trainer 400. Virtual trainer 400 includes distributed simulator servers such as terrain server 410, sensor server 420, system server 430, computer generated forces (CGF) server 440. These servers can be connected to partial simulators such as distributed mission trainers (DMTs) 450, full-scale simulators 460, command and control components 470 and debriefing systems 480. It is noted that some of components 450-460 can generate virtual entities, in addition to the virtual entities generated by any one of components 410-440, and especially by CGF server 440.

It is noted that various types of simulators exist, including non-distributed simulator, simulators that include more or less servers than those illustrated in FIG. 2, and the like. It is further noted that servers 410-440 can be connected to other components than 450-480, to fewer components or even to more components.

Substantially the same scenario is disclosed to the various participants, although various filtering processes can provide different aspects of a scenario to different persons.

Networking and data link connections enable the participants of training exercises to share information among them. In a non-limiting example of combat exercises, participants include combat vehicles (aircraft, tanks, ships, etc.) or headquarters or command centers, which monitor and control the combat exercises.

In traditional real exercises, data transaction includes only real information among and about these real parties.

The traditional real exercise and the more recently-available simulated (or “virtual”) exercise have their respective advantages and disadvantages, but are completely separate from one another. This is unfortunate, because it is often desirable to be able to simultaneously benefit from specific advantages selected from both the real and simulated environments. Current systems, however, are unable to realize these benefits.

There is thus a need for, and it would be highly advantageous to have, a simulation system that is able to combine, in real-time, aspects of both real environments and virtual environments in a controlled manner. This goal is attained by the present invention.

### SUMMARY OF THE INVENTION

According to various embodiments of the invention a method is provided. The method includes: (i) receiving, by an airborne gateway, data representative of at least one virtual entity; sensing, by an airborne sensor, signals representative of at least one real entity; and generating, by an airborne component, data representative of a virtual entity and of a real entity.

Conveniently, the method further includes displaying to an airborne user information representative of the virtual entity and of the real entity. The displaying can include distinguishing between the virtual entity and the real entity or not distinguishing between the real entity and the virtual entity.

Conveniently, the method includes filtering the data representative of at least one virtual entity. The filtering can be responsive to a class of the virtual entity and to a relationship between a virtual location of the virtual entity and a coverage area of the airborne sensor.

Conveniently, the method includes transmitting to the airborne sensor, by an airborne transmitter, radiation signals representative of the virtual entity.

Conveniently, the method includes sending to the airborne sensor data that emulates a detection of the virtual entity by the airborne sensor.

Conveniently, the method includes transmitting, by an air borne transmitter of a first airborne vehicle, to a second airborne vehicle, data representative of the virtual entity.

Conveniently, the method includes emulating an activation of system capable of affecting real objects and capable of virtually affecting virtual objects.

According to various embodiments of the invention a method is provided. The method includes: (i) transmitting, by a trainer, over a data link, towards multiple airborne vehicles, data representative of multiple virtual entities; (ii) receiving, over the data link, information relating to a airborne vehicle operations; and (iii) evaluating a state of the multiple airborne vehicles and the virtual entities in response to the received data.

Conveniently, the method includes updating data representative of multiple virtual entities and transmitting updated data representative of multiple virtual entities to the multiple airborne vehicles.

According to various embodiments of the invention an airborne device is provided. The airborne device includes: (i) an airborne gateway, adapted to receive data representative of at least one virtual entity; (ii) an airborne sensor, adapted to sense signals representative of at least one real entity; wherein the airborne device is adapted to generate data representative of a virtual entity and of a real entity.

Conveniently, the airborne device includes at least one display adapted to display to an airborne user information representative of the virtual entity and of the real entity.

Conveniently, the airborne device is adapted to distinguish between the virtual entity and the real entity.

Conveniently, the airborne device is adapted to display the real entity and the virtual entity at substantially the same manner.

Conveniently, the airborne device is adapted to filter the data representative of at least one virtual entity.

Conveniently, the airborne device is adapted to filter the data in response to a class of the virtual entity and to a relationship between a virtual location of the virtual entity and a coverage area of the airborne sensor.

Conveniently, the airborne device includes an airborne transmitter adapted to transmit to the airborne sensor radiation signals representative of the virtual entity.

Conveniently, the airborne device is adapted to send to the airborne sensor data that emulates a detection of the virtual entity by the airborne sensor.

Conveniently, the airborne device includes a mission computer that is adapted to generate data representative of a virtual entity and of a real entity.

Conveniently, the airborne device includes an airborne transmitter that is adapted to transmit data representative of the virtual entity from an airborne vehicle that comprises the airborne device to another airborne vehicle.

Conveniently, the airborne device is adapted to emulate an activation of an airborne system capable of affecting real objects and capable of virtually affecting virtual objects.

According to various embodiments of the invention a hybrid trainer is provided. The hybrid trainer includes: (i) a transmitter, adapted to transmit, over a data link, towards multiple airborne vehicles, data representative of multiple virtual entities; (ii) a receiver, adapted to receive over the data link, information relating to airborne vehicle operations; and (iii) a training information evaluator adapted to evaluate a state of the multiple airborne vehicles and the virtual entities in response to the received data.

Conveniently, the hybrid trainer is further adapted to update data representative of multiple virtual entities and to transmit updated data representative of multiple virtual entities to the multiple airborne vehicles.

### BRIEF DESCRIPTION OF THE DRAWINGS

The invention is herein described, by way of example only, with reference to the accompanying drawings, wherein:

FIG. 1 illustrates a prior art traditional training environment;

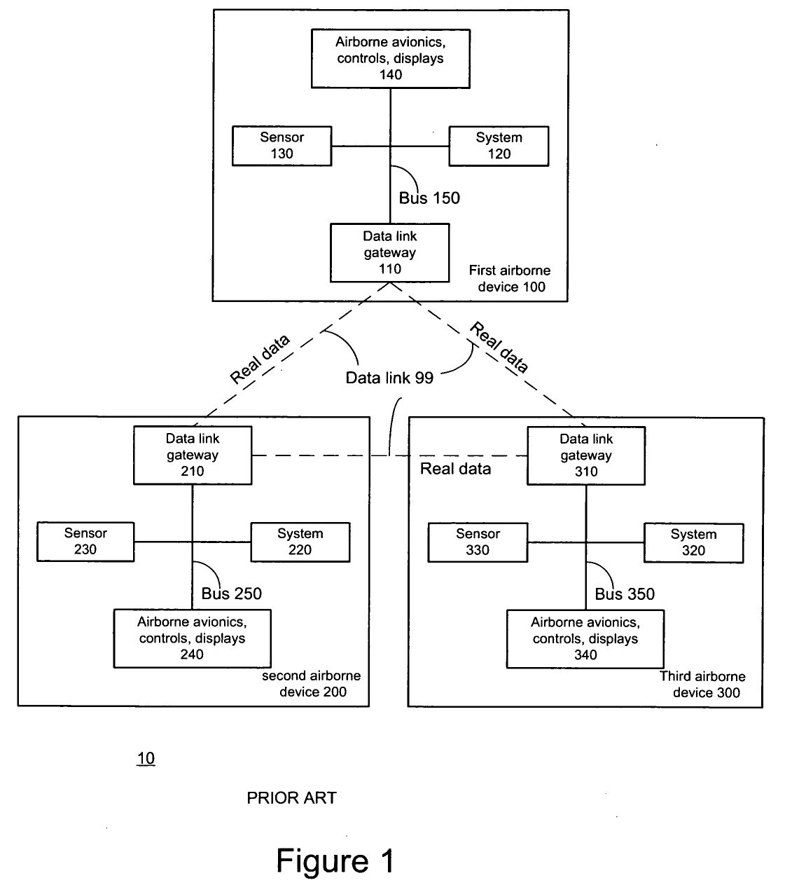

FIG. 2 illustrates a prior art simulation system;

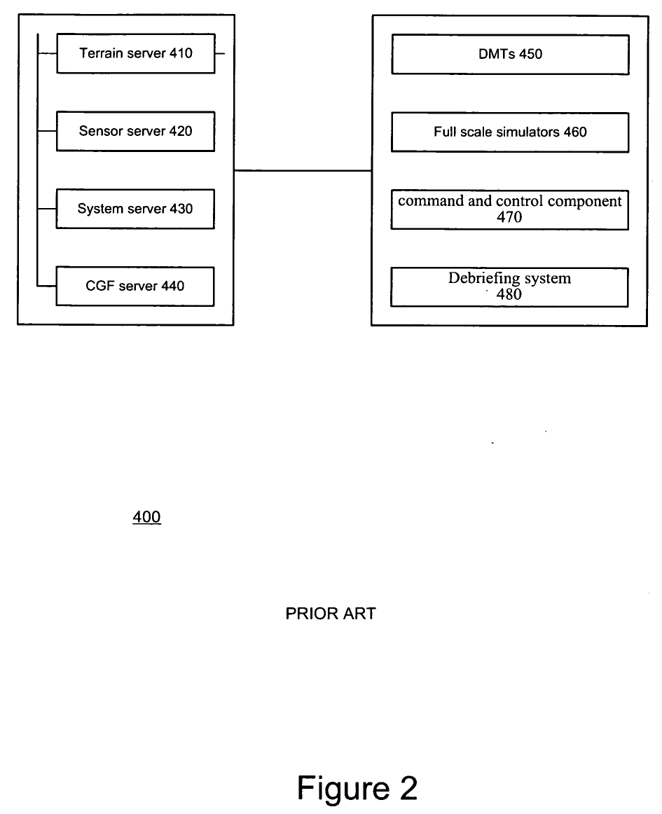

FIG. 3 illustrates a hybrid environment according to an embodiment of the invention;

FIG. 4 illustrates an airborne device according to another embodiment of the invention;

FIG. 5 illustrates an airborne device according to a further embodiment of the invention;

FIG. 6 is a flow chart of a method according to an embodiment of the invention;

FIG. 7 is a flow chart of a method according to another embodiment of the invention;

FIG. 8 is a flow chart of a method according to a further embodiment of the invention;

FIG. 9 is a flow chart of a method according to yet another embodiment of the invention;

FIG. 10 is a flow chart of a method according to yet a further embodiment of the invention;

FIG. 11 illustrates a flow chart of a method, according to an embodiment of the invention;

FIG. 12 is a flow chart of a method, according to another embodiment of the invention;

FIG. 13 illustrates a flow chart of a method, according to a further embodiment of the invention;

FIG. 14 illustrates a method, according to an embodiment of the invention; and

FIG. 15 illustrates a portion of a combat aircraft that includes a mission computer, two sensors and an airborne data link, according to an embodiment of the invention.

### DESCRIPTION OF THE PREFERRED EMBODIMENTS

The present application illustrates the invention for use in the non-limiting example of military training systems and especially systems that train airborne vehicle personnel. As detailed below, there are many other applications, configurations, and uses of the present invention.

It is noted that the method and device can manage a single real entity as well as multiple real entities, a single virtual entity as well as multiple virtual entities. Accordingly, the term entity also refers to multiple entities.

According to an embodiment of the invention a hybrid environment is provided. The hybrid environment (also referred to as combined environment) can be used for various purposes including, for example, modeling, simulation, testing, training, research, development, and so forth. Conveniently, real and virtual environments, and especially data relating to virtual and real entities can be selectively blended together.

According the present invention, the virtual and real environments are combined into one unified environment. In an embodiment of the present invention, this combining includes bi-directional update between these two environments. All (or some of) participants in the exercise can share the same view (or portions of that view) of the combined environment, which appears to them as a “real” picture. In an embodiment of the present invention, virtual and real data are combined and processed for display as “real” data for the end-user.

Other non-limiting examples of environments which can be handled by the present invention include: civilian aircraft traffic management, infantry combat exercises, naval warfare simulations, firefighting, disaster management training, drills and exercises, and other environments requiring coordinated teamwork in real-time situations.

The present invention enables obtaining selective advantages of the two environments, some are listed below.

Virtual environment advantages include the ability to conduct complicated and massive trainings with: (i) high level of safety and security, reducing hazards and minimizing the risk of real physical danger; (ii) reduction in resource utilization, by reducing the need to use and coordinate real equipment; (iii) ease in developing and testing new doctrines, strategies, tactics, and exploring new theaters of operation, (iv) the ability to develop and examine new equipment and techniques in extreme conditions, (v) full scale mission rehearsal.

Real environment advantages include the ability to expose the participants to the look, feel, and behavior of real equipment, vehicles, and situations. Real environment provides an authentic sphere for the participant, and provides an accuracy level which can be obtained only in the real world, without the artifices and idiosyncrasies of simulations.

According to an embodiment of the present invention at least some of the participants are unaware of any distinction between real and virtual entities (e.g., a pilot would not be able to tell the difference between a “real” target and a “virtual” target). This can be done by concealing one or more entity attribute or by not generating information representative of the type (real/virtual) of the entities.

According to another embodiment of the invention real entities are displayed in manner that is different from the manner in which virtual entities are displayed. For example, different colors and/or different shapes can represent real and virtual entities.

According to yet another embodiment of the invention some virtual entities are displayed as real entities while other virtual entities are displayed as virtual entities.

In addition, the ability to combine real and virtual environments offers many further and unexpected advantages, affording heretofore unrealized opportunities for the development and evaluation of new doctrines, strategies, and tactics; performing diagnostics and critical testing; exploring and innovating new theaters of operation, and exposing real personnel and equipment thereto; performing experiments and correlating “what if” scenarios; stressing existing real systems to determine performance characteristics, limits, and failure modes; and so on.

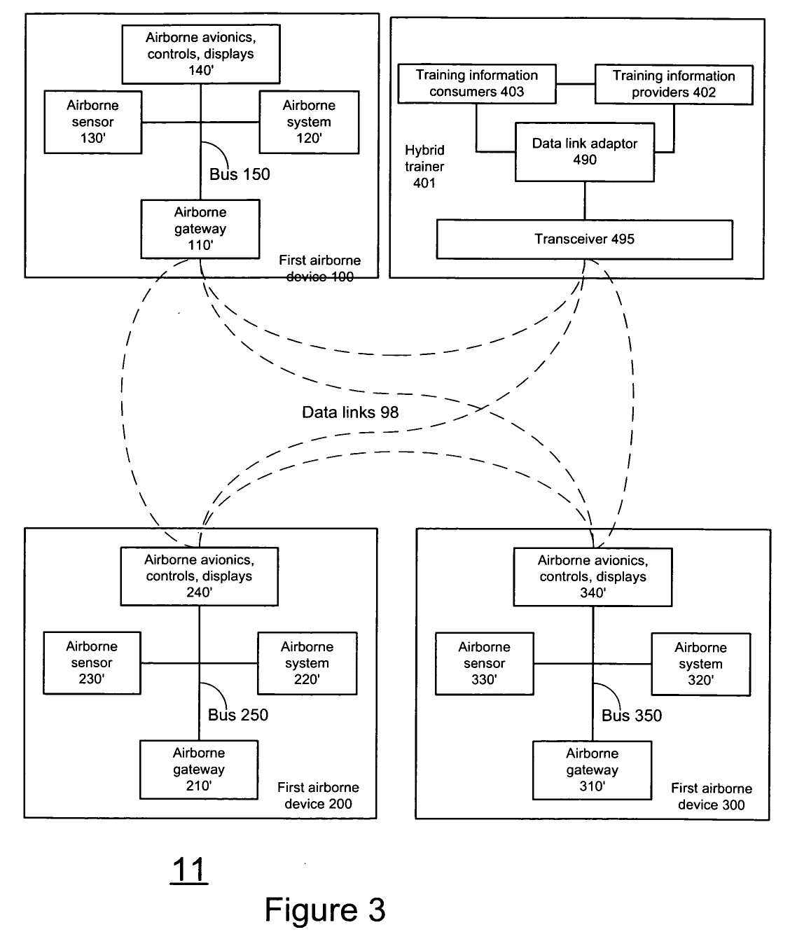

FIG. 3 illustrates a combined environment 11 according to an embodiment of invention.

Combined environment 11 includes airborne devices 100′-300′ that are conveyed by three airborne vehicles. Combined environment 11 also includes virtual trainer 401. The hybrid trainer 401 as well as airborne components 100′-300′ can exchange data relating to real and virtual entities using data links 98.

It is noted that the number of airborne devices can differ from three, that other vehicles can participate in the training, and the other well known devices and method can be used to generate the virtual environment, as well as view the hybrid environment.

Airborne device 100′ includes multiple airborne components such as airborne gateway 110′, airborne system 120′, airborne sensor 130′ and airborne avionics, control and displays 140′.

A typical airborne avionics, control and display 140′ includes one or more mission computers and multiple displays, such as but not limited to a radar display, a tactical display and the like. Entities are usually displayed at least on the tactical display.

Airborne sensor 130′ can be analogues to sensor 130. According to an embodiment of the invention airborne sensor 130′ includes an input port 131′ for receiving data from the airborne gateway 110′. This data emulates a detection of a virtual entity by airborne sensor 130′. It is noted that some prior art sensors 130 include this capability. According to an embodiment of the invention such a dedicated input port is not required, and data representative of a virtual entity can, for example, be transmitted over bus 150′.

Airborne sensor 130′ is adapted to make readings of data of equipment or physical entities and display the data to participants, with no effect on external entities. Such a sensor can be a radar, a passive electronic warfare warning system and the like.

Airborne system 120′ is also capable of affecting external entities (e.g., an Electronic Warfare system which can deploy decoys, flare, chaff, etc. According to an embodiment of the invention airborne system 120′ also includes an input port 121′ for receiving data from the airborne gateway 110′. This data emulates a detection of a virtual entity by airborne system 120′. It is noted that some prior art systems 120 include this capability. According to an embodiment of the invention such a dedicated input port is not required, and data representative of a virtual entity can, for example, be transmitted over bus 150′.

The airborne gateway 110′ can be adapted to receive data via one or more data links. The data can include data relating to the state real entities and well as data representative of virtual entities.

According to one embodiment of the invention airborne components 110′-140′ are connected to each other via bus 150′. Thus, data representative of virtual entities can be sent by airborne gateway 110′ via bus 150′. According to another embodiment of the invention data representative of virtual entities can be sent by airborne gateway 110′ via bus 150′.

According to an embodiment of the invention the airborne device 100′ can also transmit information relating to the state of the airborne vehicle that conveys it and/or operations made by the pilot or system operator. According to an embodiment of the invention one or more airborne component can evaluate (for example score) the performance of the pilot or a system operator. This can include evaluating missile (or radar) evasive maneuvers, evaluating whether a virtual entity was virtually destroyed by the airborne vehicle and the like. These score as well as other types of output relating to the training session are transmitted, via airborne gateway, to the hybrid trainer 401.

Hybrid trainer 401 includes training information providers 402 as well as training information consumers 403. It is noted that the training information providers 402 and/or the training information consumers 403 can include elements of virtual trainer 400. For example training information consumers 403 can include any component out of components 450-490, while training information providers 402 van include any component out of components 410-440. It is further noted that some components (such as simulators) can act as both training information consumers and training information providers, especially when multiple simulators participate in the same training session in which multiple simulated airborne vehicles participate.

Hybrid trainer also includes a data link adaptor 490 and transceiver 495 (also referred to as data link gateway distributor/collector of data).

According to an embodiment of the invention the training information providers 402 are responsive to data provided from the airborne devices 100′-300′. This data can reflect real entities such as the airborne vehicles that convey airborne devices 100′-300′, as well as virtual entities provided by the airborne devices 100′-300′.

The data relating to the real entities can include their status (location, velocity, ammunition and fuel status), information relating to various maneuvers or operations preformed by the real entities in relation to real or virtual entities (simulated activation of active electronic warfare system, simulated missile launch), as well as scores representative of the effectiveness of various operations executed or virtually executed by the vehicle platform ambers.

Accordingly, a training session involves representing the real entities in the hybrid environment, evaluating their relationships with virtual entities and the like.

According to an embodiment of the invention at least

Data link adaptor 490 operates bi-directionally. It can receive information relating to virtual and/or real entities from the training information providers 402, and converts it to a format readable by the airborne devices 100′-300′. It also receives data from the airborne devices 100′-300′ converts it to a format readable by the training information providers 402 and sends it to the training information providers.

The transceiver 495 transmits and received data to and from airborne devices 100′-300′. The transmission (as well as the reception) can be implemented by various prior methods including multicast transmissions, unicast transmissions, broadcast transmission, time division multiplex techniques, frequency division multiple techniques, code division multiplexing techniques, wide band transmission, ultra wide band transmission, narrowband transmission and the like. The transmission (as well as the reception) can be made solely over wireless medium, partially over wired networks, using satellite communication, and the like.

Components 490 and 495 allow to exchange data about real entities and/or virtual entities between the airborne devices 100′-300′ and between the hybrid trainer 401.

Components 490 and 495 can filter virtual information that is sent towards airborne devices 100′-300′. They can, according to predefined rules, determine when to send data to airborne devices, which virtual and/or updated real information should be sent to the airborne devices 100′-300′, can mark virtual entities as real entities and the like.

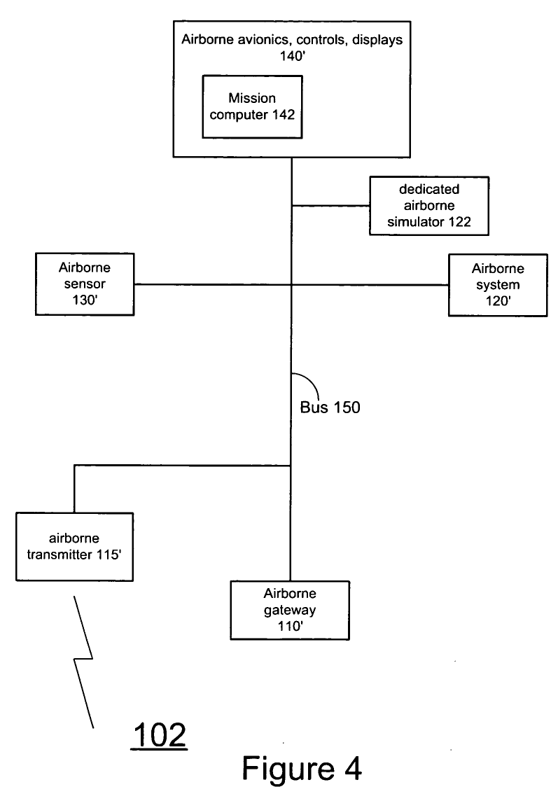

FIG. 4 illustrates an airborne device 102 according to another embodiment of the invention.

Airborne device 102 can generate virtual entities, and then perform a certain training session that can be responsive to virtual and real entities. It can also transmit signals (by using airborne transmitter 115) that are representative of the virtual entity or even send data by a data link, representative of the virtual entity, to other airborne vehicles and even to a ground based simulator.

The simulation can be executed by a dedicated airborne simulator 122 or by the mission computer 142 that executes a simulation code. It is noted that both the airborne simulator 122 and the mission computer 124 can participate in a certain training session.

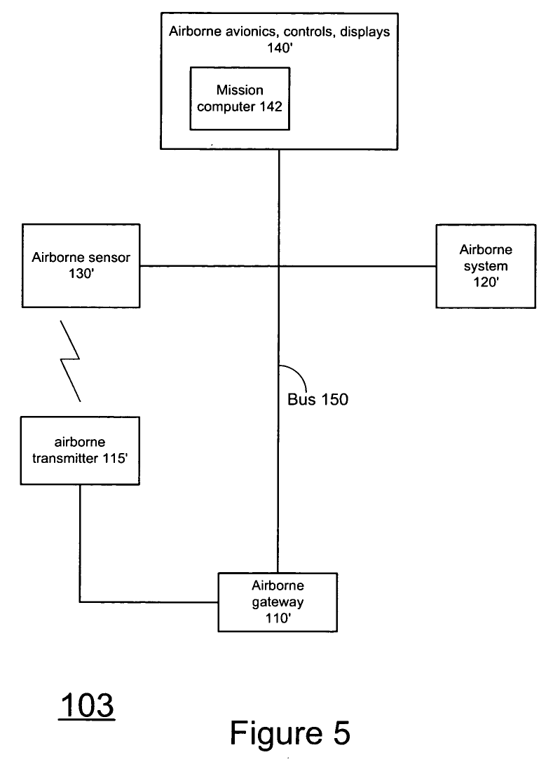

FIG. 5 illustrates an airborne device 103 according to an embodiment of the invention. Airborne device 103 includes an airborne transmitter 115′ that receives data representative of virtual entities from an airborne component such as airborne gateway 110′ and transmits to airborne sensor 130′, radiation signals representative of the virtual entity.

It is noted that the airborne transmitter 115′ can transmit relatively low power signals, while airborne transmitter 115 of FIG. 5 can be required to transmit medium level signals as well as high power signals, so that its transmissions will be received by other airborne vehicles.

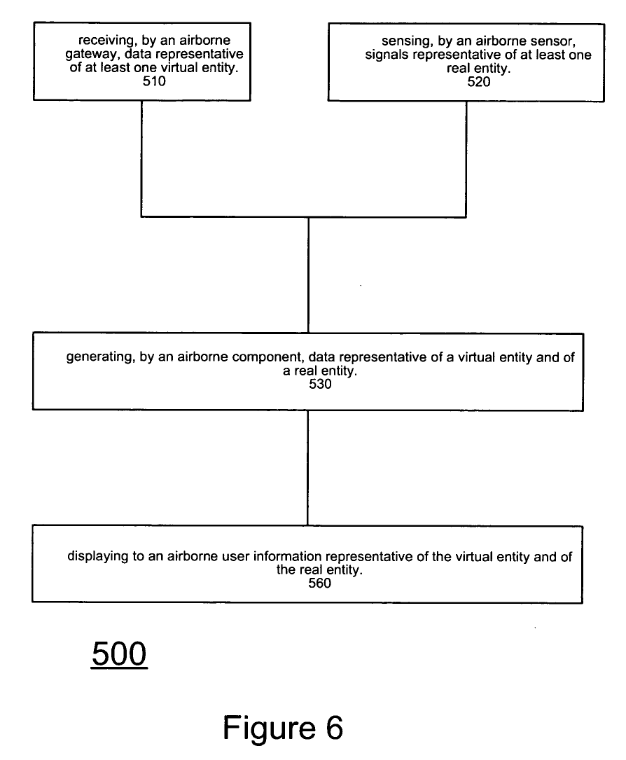

FIG. 6 is a flow chart of a method 500, according to an embodiment of the invention.

Method 500 starts by stages 510 and 520. Stage 510 includes receiving, by an airborne gateway, data representative of at least one virtual entity.

Stage 520 includes sensing, by an airborne sensor, signals representative of at least one real entity.

Stage 520 and 510 are followed by stage 530 of generating, by an airborne component, data representative of a virtual entity and of a real entity. The airborne component can be the airborne gateway, a mission computer or other airborne component.

Stage 550 is followed by stage 560 of displaying to an airborne user information representative of the virtual entity and of the real entity. The displaying is responsive to data provided by the airborne sensor and by the airborne gateway.

Stage 560 can include at least one of the following: (i) distinguishing between the virtual entity and the real entity, (ii) displaying the virtual entity and the real entity without distinguishing between the real entity and the virtual entity, or (iii) displaying some virtual entities as real entities and displaying some virtual entities as virtual entities.

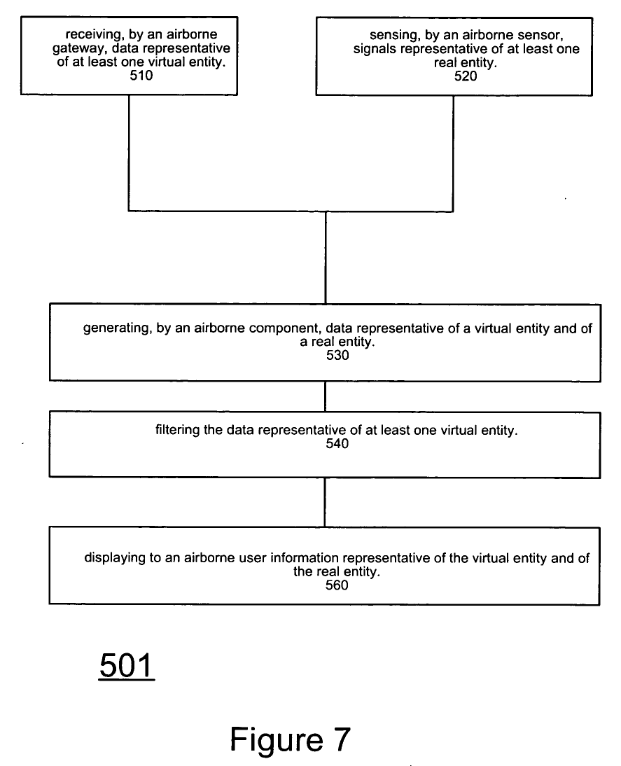

FIG. 7 is a flow chart of a method 501, according to an embodiment of the invention.

Method 501 differs from method 500 by including stage 540. Stage 540 follows stage 530 and precedes stage 560.

Stage 540 includes filtering the data representative of at least one virtual entity. Conveniently the filtering is executed by the airborne gateway but this is not necessarily so. For example, the filtering can be done by another component that has processing capabilities, such as but not limited to a mission computer.

Conveniently, the filtering is responsive to a class (enemy or friendly) of the virtual entity and to a relationship between a virtual location of the virtual entity and a coverage area of the airborne sensor. For example, a virtual enemy entity can be displayed if it would have been detected by the airborne sensor of the airborne device, if it was a real enemy entity. Yet for another example, a friendly entity can be displayed if it was detected by a sensor or reported to the airborne device via the data link.

Conveniently, the filtering is responsive to filtering rules that may define the maximal number (or minimal number) of displayed virtual entities, the maximal (or minimal) ratio between the number of displayed virtual entities and displayed real entities, and the like.

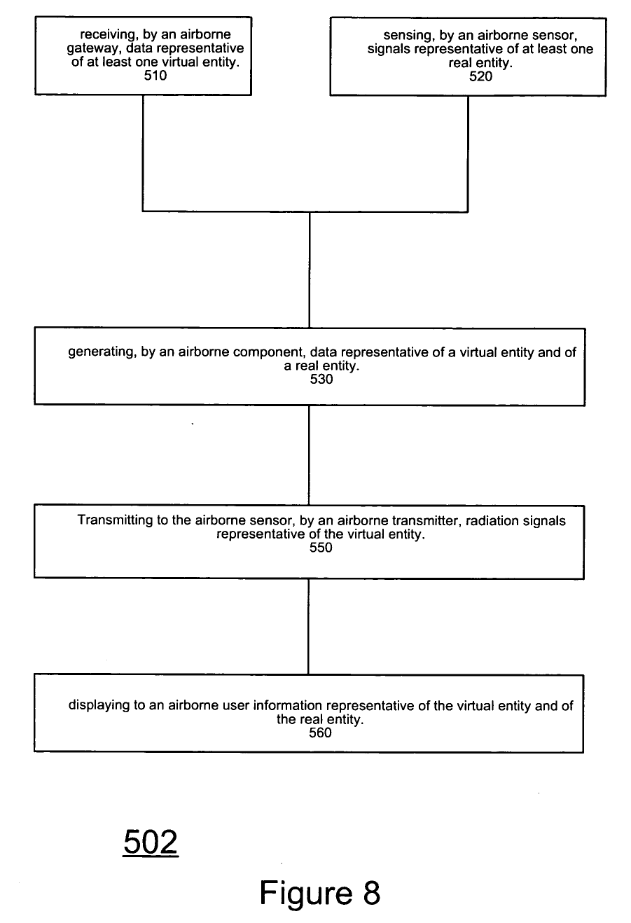

FIG. 8 is a flow chart of a method 502, according to an embodiment of the invention.

Method 502 differs from method 500 by including stage 550. Stage 550 includes transmitting to the airborne sensor, by an airborne transmitter, radiation signals representative of the virtual entity. The airborne transmitter can be controlled to the airborne gateway that sends it transmission instructions.

Those of skill in the art will appreciate that method 502 can also include stage 540.

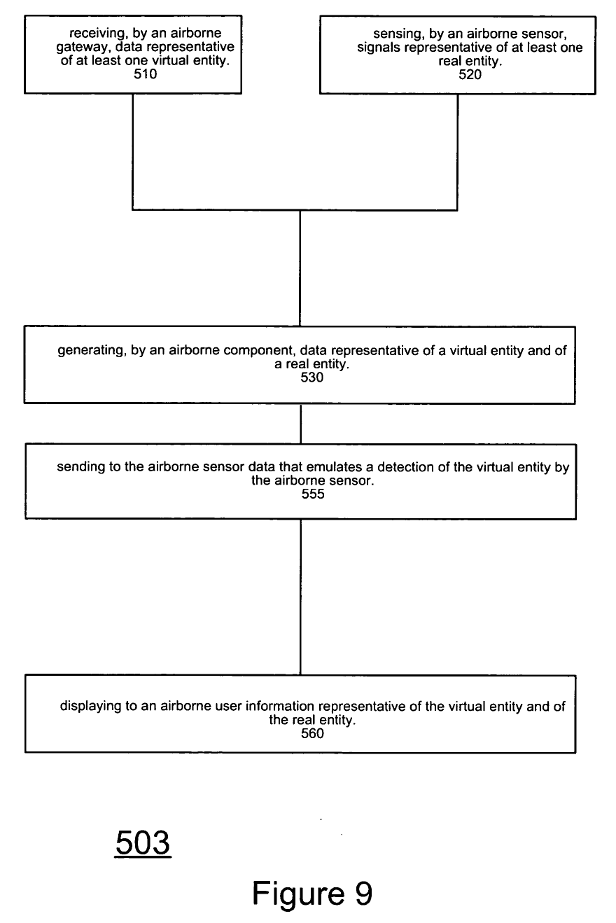

FIG. 9 is a flow chart of a method 503, according to an embodiment of the invention.

Method 503 differs from method 500 by including stage 555. Stage 555 includes sending to the airborne sensor data that emulates a detection of the virtual entity by the airborne sensor.

Those of skill in the art will appreciate that method 503 can also include stage 540.

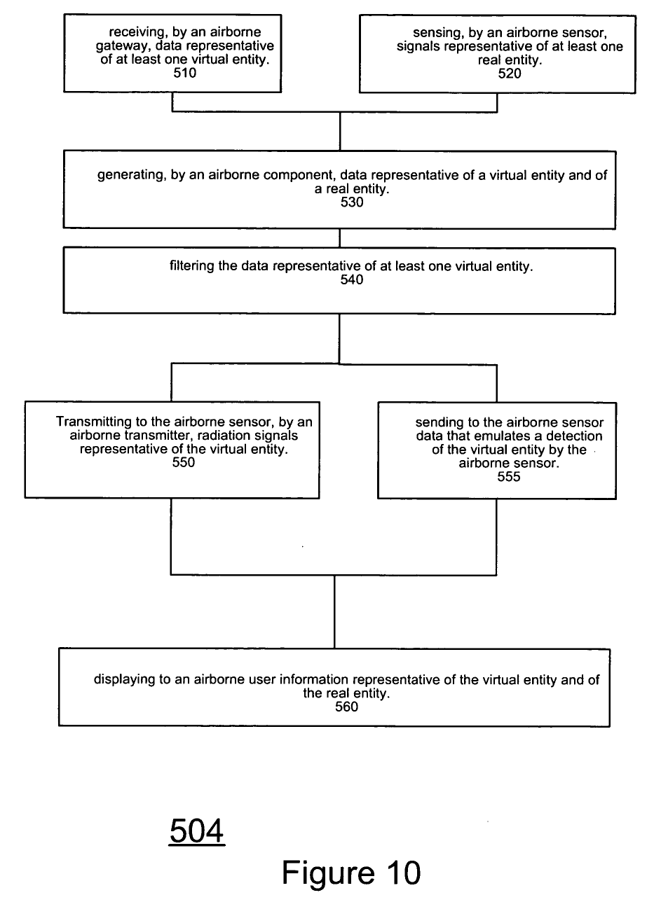

FIG. 10 is a flow chart of a method 504, according to an embodiment of the invention.

Method 504 differs from method 500 by including stages 540, 550 and 555. It is noted that method 504 can include selecting one stage out of stage 550 and 555. The selection can be responsive to the configuration of the aircraft and especially to the transmission capabilities of the transmitter. For example, some airborne transmitters can emulate certain entities but are not able to emulate other entities.

Yet for another example stage 550 can be used for emulating a certain virtual entity while stage 555 can be used for emulating another virtual entity.

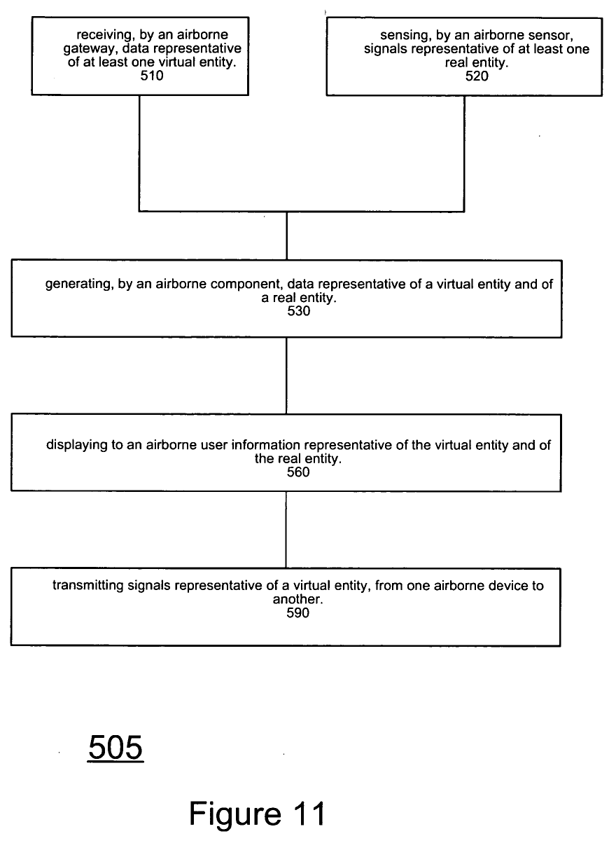

FIG. 11 illustrates a flow chart of method 505, according to an embodiment of the invention.

Method 505 differs from method 500 by including stage 590 of transmitting signals representative of a virtual entity, from one airborne device to another. These signals can be conveyed over the data link or can be radiation signals that should be detected by the sensor of the other airborne sensor.

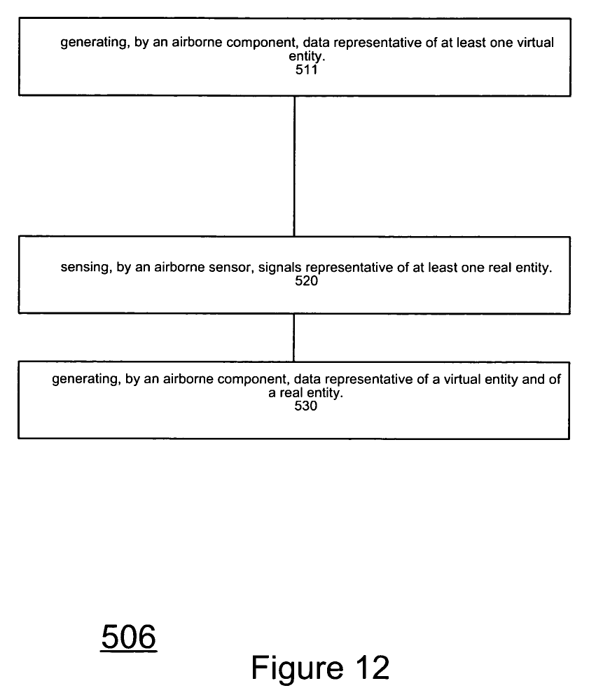

FIG. 12 is a flow chart of a method 506, according to an embodiment of the invention.

Method 506 starts by stages 511 and 520. Stage 511 includes generating, by an airborne component, data representative of at least one virtual entity. The airborne component can be a dedicated airborne simulator, such as airborne simulator 122 or mission computer 142 that executes a simulation code.

Stage 520 includes sensing, by an airborne sensor, signals representative of at least one real entity.

Stage 520 and 511 are followed by stage 530 of generating, by an airborne component, data representative of a virtual entity and of a real entity. The airborne component can be the airborne gateway, a mission computer or other airborne component.

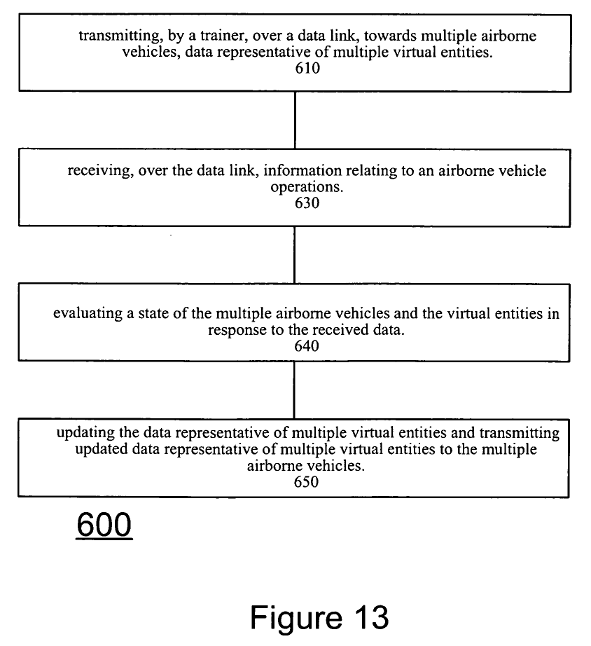

FIG. 13 illustrates a flow chart of method 600, according to an embodiment of the invention.

Method 600 starts by stage 610 of transmitting, by a trainer, over a data link, towards multiple airborne vehicles, data representative of multiple virtual entities.

Stage 610 is followed by stage 620 of receiving, over the data link, information relating to a airborne vehicle operations.

Stage 630 is followed by stage 640 of evaluating a state of the multiple airborne vehicles and the virtual entities in response to the received data.

Stage 640 is followed by stage 650 of updating the data representative of multiple virtual entities and transmitting updated data representative of multiple virtual entities to the multiple airborne vehicles.

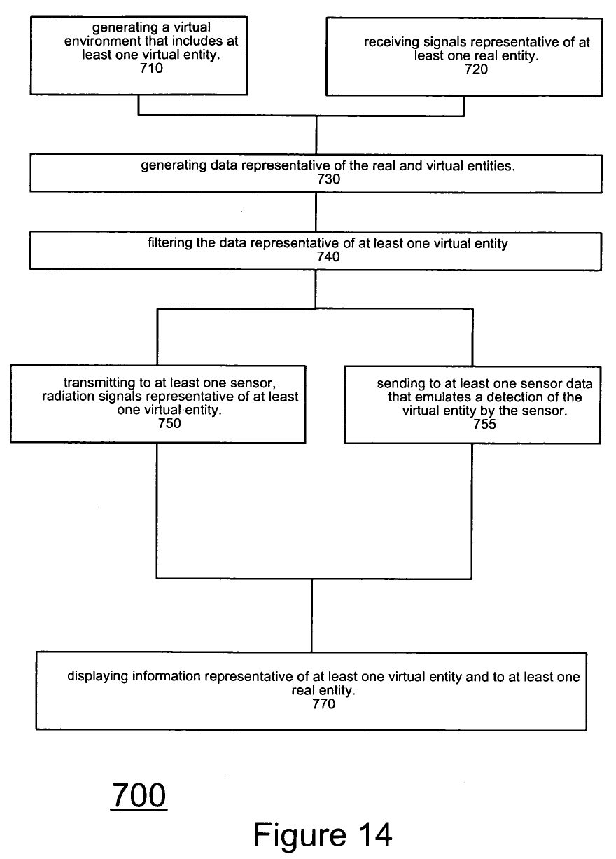

FIG. 14 illustrates method 700, according to an embodiment of the invention.

Method 700 starts by stages 710 and 720. Stage 710 includes generating a virtual environment that includes at least one virtual entity.

Stage 710 includes receiving signals representative of at least one real entity. The reception can be made via sensors. It is noted that information relating to at least one real entity can be provided in other manners. For example, information relating to other friendly real entities can be provided by a data link or by a component other that the sensors.

Stage 710 and 720 are followed by stage 730 of generating data representative of the real and virtual entities.

Stage 730 can be followed by stage 770. According to various embodiments of the invention method 700 includes at least one of optional stages 740, 750 and 755.

Stage 740 includes filtering the data representative of at least one virtual entity. Conveniently the filtering is executed by the airborne gateway but this is not necessarily so. For example, the filtering can be done by another component that has processing capabilities, such as but not limited to a mission computer.

Stage 750 includes transmitting to at least one sensor, radiation signals representative of at least one virtual entity. Stage 755 includes sending to at least one sensor data that emulates a detection of the virtual entity by the sensor. Stages 750 and 755 are followed by stage 770.

Stage 770 includes displaying information representative of at least one virtual entity and to at least one real entity. The displaying is responsive to data provided during any one of stages 710-755.

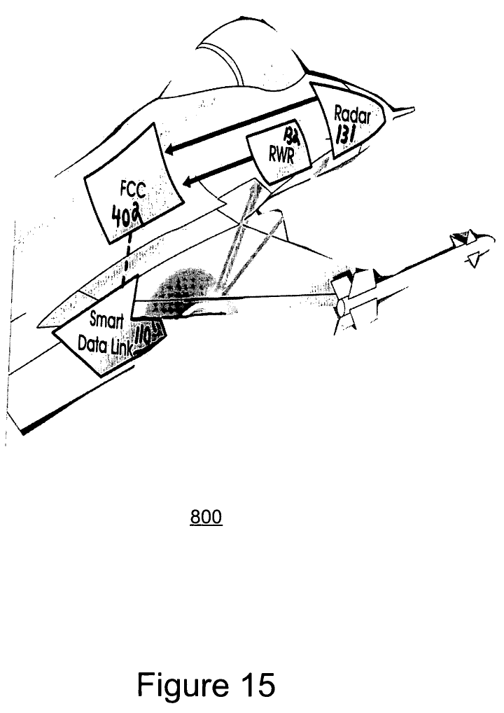

FIG. 15 illustrates a portion of a combat aircraft 800 that includes a mission computer (FCC) 402, two sensors 131 (Radar) and 132 (RWR) and an airborne gateway (Smart Data link) 110′, according to an embodiment of the invention.

While the invention has been described with respect to a limited number of embodiments, it will be appreciated that many variations, modifications and other applications of the invention may be made.

1. A method, comprising: receiving, by an airborne gateway, data representative of at least one virtual entity; sensing, by an airborne sensor, signals representative of at least one real entity; and generating, by an airborne component, data representative of a virtual entity and of a real entity.

2. The method according to claim 1 further comprising displaying to an airborne user information representative of the virtual entity and of the real entity.

3. The method according to claim 2 wherein the displaying comprises distinguishing between the virtual entity and the real entity.

4. The method according to claim 2 wherein the displaying without distinguishing between the real entity and the virtual entity.

5. The method according to claim 1 further comprising filtering the data representative of at least one virtual entity.

6. The method according to claim 5 wherein the filtering is responsive to a class of the virtual entity and to a relationship between a virtual location of the virtual entity and a coverage area of the airborne sensor.

7. The method according to claim 1 further comprising transmitting to the airborne sensor, by an airborne transmitter, radiation signals representative of the virtual entity.

8. The method according to claim 1 wherein further comprising sending to the airborne sensor data that emulates a detection of the virtual entity by the airborne sensor.

9. A method, comprising:
transmitting, by a trainer, over a data link, towards multiple airborne vehicles, data representative of multiple virtual entities; receiving, over the data link, information relating to a airborne vehicle operations; evaluating a state of the multiple airborne vehicles and the virtual entities in response to the received data.

10. The method according to claim 9 further comprising updating data representative of multiple virtual entities and transmitting updated data representative of multiple virtual entities to the multiple airborne vehicles.

11. An airborne device comprising:
an airborne gateway, adapted to receive data representative of at least one virtual entity; an airborne sensor, adapted to sense signals representative of at least one real entity; wherein the airborne device is adapted to generate data representative of a virtual entity and of a real entity.

12. The airborne device according to claim 11 wherein the airborne device is adapted to display the real entity and the virtual entity at substantially the same manner.

13. The airborne device according to claim 11 further adapted to filter the data representative of at least one virtual entity.

14. The airborne device according to claim 13 wherein the airborne device is adapted to filter the data in response to a class of the virtual entity and to a relationship between a virtual location of the virtual entity and a coverage area of the airborne sensor.

15. The airborne device according to claim 12 further comprising an airborne transmitter adapted to transmit to the airborne sensor radiation signals representative of the virtual entity.

16. The airborne device according to claim 14 further adapted to send to the airborne sensor data that emulates a detection of the virtual entity by the airborne sensor.

17. The airborne device according to claim 14 wherein the airborne device comprises a mission computer that is adapted to generate data representative of a virtual entity and of a real entity.

18. The airborne device according to claim 14 further comprising an airborne transmitter, that is adapted to transmit data representative of the virtual entity from an airborne vehicle that comprises the airborne device to another airborne vehicle.

19. The airborne device according to claim 14 further adapted to emulate an activation of an airborne system capable of affecting real objects and capable of virtually affecting virtual objects.
